(19) United States
(12) Patent Application Publication
(10) Pub. No.: US 2020/0051212 A1
(43) Pub. Date: Feb. 13, 2020

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: Kotaro Kitajima, Yokohama-shi (JP)

(21) Appl. No.: 16/527,169

(22) Filed: Jul. 31, 2019

(30) Foreign Application Priority Data
Aug. 7, 2018 (JP) 2018-148851

(51) Int. Cl. G06T 5/00; H04N 5/243; H04N 9/77

(52) U.S. Cl. CPC G06T 5/001; G06T 5/008; G06T 2207/20104; H04N 9/77; G06T 2200/24; H04N 5/243

(57) ABSTRACT

There is provided an image processing apparatus. A setting unit sets a correction region in an object of an image. An acquisition unit acquires normal information relating to the correction region. A determination unit determines, based on the normal information, a parameter of a virtual light source that performs virtual light irradiation on the object. A correction unit corrects the image such that light irradiation by the virtual light source is applied.

### BACKGROUND OF THE INVENTION

### Field of the Invention

The present invention relates to an image processing apparatus, an image processing method, and a storage medium.

### Description of the Related Art

Conventionally, a technology of performing relighting by irradiating an object in a shot image with light from a virtual light source is known. It thereby becomes possible to brighten dark regions such as shadows that occur due to ambient light and obtain a preferable image.

For example, Japanese Patent Laid-Open No. 2010-135996 discloses a technology for performing pseudo-lighting processing on a shot image. Specifically, processing for determining the lighting intensity of the virtual light source based on the maximum luminance of the face and the luminance of shadows, and determining the direction of the virtual light source to be the opposite direction to the direction of ambient light is performed. Also, the determined direction and intensity of the virtual light source can be manipulated by a user operation. The strong contrast between light and dark that occurs in the vicinity of the face can thereby be reduced.

According to Japanese Patent Laid-Open No. 2010-135996, the direction and intensity etc., of the virtual light source can be determined by a user operation. However, there are also cases where manipulating the direction, intensity and range of the virtual light source is not intuitive to the user. Accordingly, the user may have difficulty adjusting parameters of the virtual light source to achieve the intended brightness in a desired region of an object.

### SUMMARY OF THE INVENTION

The present invention has been made in consideration of circumstances such as the above, and provides a technology that enables parameters of a virtual light source that irradiates an object with virtual light to be determined with a simple user operation.

According to a first aspect of the present invention, there is provided an image processing apparatus comprising at least one processor and/or at least one circuit which function as: a setting unit configured to set a correction region in an object of an image; an acquisition unit configured to acquire normal information relating to the correction region; a determination unit configured to determine, based on the normal information, a parameter of a virtual light source that performs virtual light irradiation on the object; and a correction unit configured to correct the image such that light irradiation by the virtual light source is applied.

According to a second aspect of the present invention, there is provided an image processing method executed by an image processing apparatus, comprising: setting a correction region in an object of an image; acquiring normal information relating to the correction region; determining, based on the normal information, a parameter of a virtual light source that performs virtual light irradiation on the object; and correcting the image such that light irradiation by the virtual light source is applied.

According to a third aspect of the present invention, there is provided a non-transitory computer-readable storage medium which stores a program for causing a computer to execute an image processing method comprising: setting a correction region in an object of an image; acquiring normal information relating to the correction region; determining, based on the normal information, a parameter of a virtual light source that performs virtual light irradiation on the object; and correcting the image such that light irradiation by the virtual light source is applied.

Further features of the present invention will become apparent from the following description of exemplary embodiments with reference to the attached drawings.

### BRIEF DESCRIPTION OF THE DRAWINGS

FIG. 1 is a block diagram showing a configuration of a digital camera 100.

FIG. 2 is a block diagram showing a configuration of an image processing unit 105.

FIG. 3 is a block diagram showing a configuration of a relighting processing unit 114.

FIG. 4 is a diagram showing the relationship between camera shooting coordinates and an object.

FIG. 5 is a flowchart of relighting parameter determination processing.

FIGS. 6A and 6B are diagrams showing user operations when setting a relighting region.

FIGS. 7A to 7C are diagrams illustrating a method of calculating a representative normal.

FIGS. 8A to 8C are diagrams illustrating a method of determining parameters of a virtual light source that correspond to each of three relighting modes.

FIGS. 9A to 9C are diagrams showing a shot image before and after relighting.

FIGS. 10A and 10B are diagrams showing a processing example in the case where a selection region selected by a user is large.

### DESCRIPTION OF THE EMBODIMENTS

Hereinafter, embodiments of the present invention will be described with reference to the attached drawings. Elements that are given the same reference numerals throughout all of the attached drawings represent the same or similar elements. Note that the technical scope of the present invention is defined by the claims, and is not limited by the following respective embodiments. Also, not all of the combinations of the aspects that are described in the embodiments are necessarily essential to the present invention. Also, the aspects that are described in the individual embodiments can be combined as appropriate.

In the following embodiments, description will be given taking a configuration in which an image processing apparatus is applied to a digital camera (image capturing apparatus) as an example.

### First Embodiment

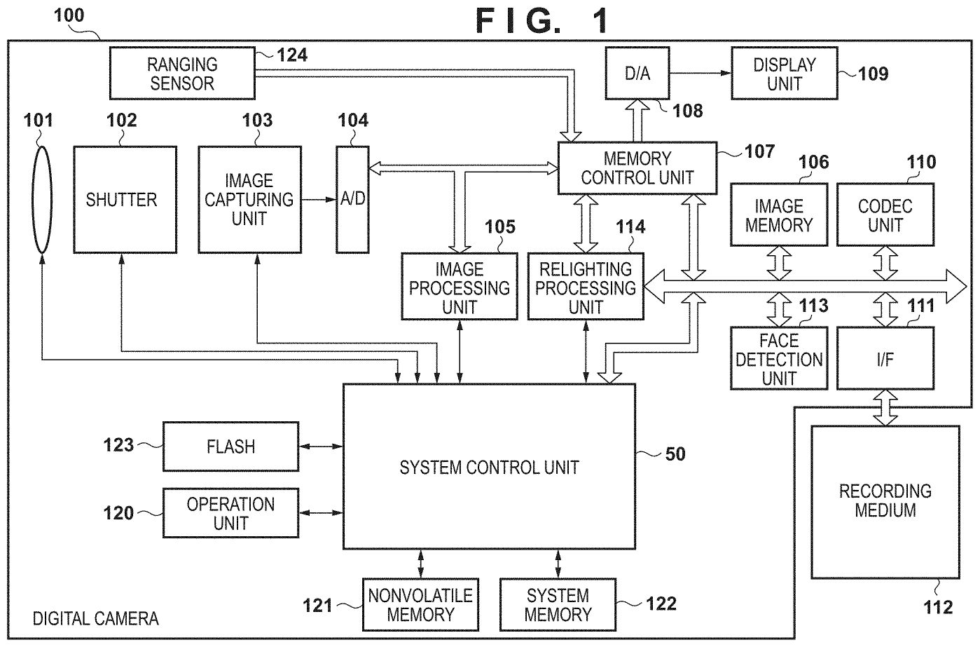

FIG. 1 is a block diagram showing a configuration of a digital camera 100. In FIG. 1, reference numeral 101 denotes a group of lenses that includes a zoom lens and a focus lens. Reference numeral 102 denotes a shutter that has a diaphragm function. Reference numeral 103 denotes an image capturing unit that is constituted by a CCD or CMOS device or the like that converts optical images into electrical signals. Reference numeral 104 denotes an A/D converter that converts analog signals into digital signals. Reference numeral 105 denotes an image processing unit that performs various image processing such as white balance processing, gamma processing, edge enhancement processing and color correction processing on image data that is output by the A/D converter 104. Reference numeral 106 denotes an image memory. Reference numeral 107 denotes a memory control unit that controls the image memory 106. Reference numeral 108 denotes a D/A converter that converts input digital signals into analog signals. Reference numeral 109 denotes a display unit that includes an LCD and the like. Reference numeral 110 denotes a codec unit that compression encodes and decodes image data.

Reference numeral 111 denotes an interface (I/F) with a recording medium 112. Reference numeral 112 denotes a recording medium such as a memory card or a hard disk. Reference numeral 113 denotes a face detection unit that detects regions in which faces appear within shot images. Reference numeral 114 is a relighting processing unit that performs relighting processing on shot images. Reference numeral 50 denotes a system control unit that controls the overall system of the digital camera 100. Reference numeral 121 denotes a nonvolatile memory such as an EEPROM that stores programs, parameters and the like. Reference numeral 122 denotes a system memory to which constants, variables, programs read out from the nonvolatile memory 121 and the like for use in operations by the system control unit 50 are extracted. Reference numeral 123 denotes a flash (light source apparatus). Reference numeral 124 denotes a ranging sensor that measures the distance to an object, and outputs distance information corresponding to pixel units of a shot image as a two-dimensional distance map image.

Next, basic operations at the time of shooting an object in the digital camera 100 configured as described above will be described. The image capturing unit 103 photoelectrically converts light that is incident via the lens 101 and the shutter 102, and outputs the resultant analog signals to the A/D converter 104 as input image signals. The A/D converter 104 converts the analog image signals that are output by the image capturing unit 103 into digital image signals, and outputs the digital image signals to the image processing unit 105.

The image processing unit 105 performs gamma processing, edge enhancement processing, color conversion processing such as white balance and the like on image data from the A/D converter 104 or image data from the memory control unit 107. Also, the image processing unit 105 performs predetermined evaluation value calculation processing using the face detection result of the face detection unit 113 and captured image data. The system control unit 50 performs exposure control and ranging control based on the obtained evaluation value. AF (auto focus) processing, AE (auto exposure) processing, AWB (auto white balance) processing and the like that employ a TTL (Through-The-Lens) system can thereby be performed.

Image data output by the image processing unit 105 is written to the image memory 106 via the memory control unit 107. The image memory 106 stores image data output by the image capturing unit 103 and image data for displaying on the display unit 109. The D/A converter 108 converts data for image display that is stored in the image memory 106 into analog signals and supplies the analog signals to the display unit 109. The display unit 109 performs display that depends on the analog signals from the D/A converter 108 on a display device such as an LCD.

The codec unit 110 compression encodes image data recorded in the image memory 106, based on a standard such as JPEG or MPEG. The system control unit 50 stores encoded image data in the recording medium 112 via the I/F 111.

Hereinabove, the basic operations at the time of shooting an object have been described. Besides the above basic operations, the system control unit 50 realizes various processing of the present embodiment which will be described later, by executing programs recorded in the aforementioned nonvolatile memory 121. The programs referred to here are programs for executing various flowcharts described later in the present embodiment. At this time, constants, variables, programs read out from the nonvolatile memory 121 and the like for use in operations by the system control unit 50 are extracted to the system memory 122.

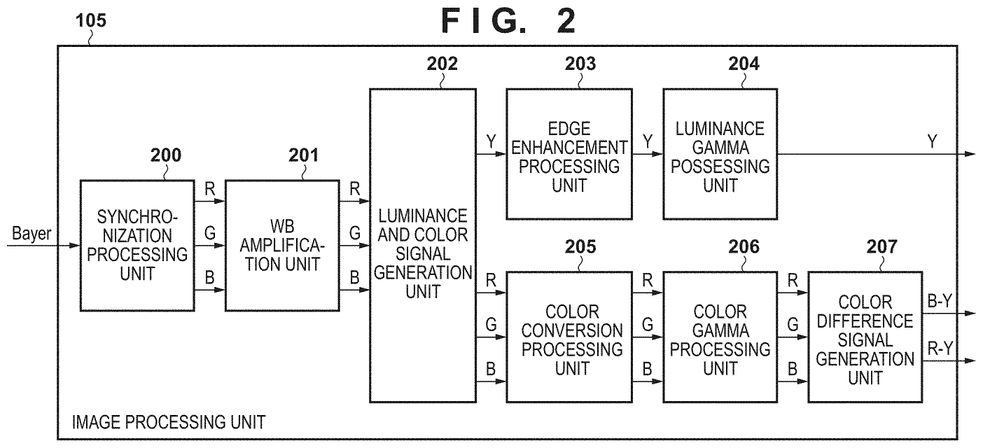

Next, the image processing unit 105 will be described in detail, with reference to FIG. 2. FIG. 2 is a block diagram showing a configuration of the image processing unit 105. In FIG. 2, reference numeral 200 denotes a synchronization processing unit, 201 denotes a WB amplification unit, and 202 denotes a luminance and color signal generation unit. Reference numeral 203 denotes an edge enhancement processing unit, 204 denotes a luminance gamma possessing unit, 205 denotes a color conversion processing unit, 206 denotes a color gamma processing unit, and 207 denotes a color difference signal generation unit.

Operations in the image processing unit 105 will now be described. The image signals output by the A/D converter 104 of FIG. 1 are input to the image processing unit 105. The image signals input to the image processing unit 105 are input to the synchronization processing unit 200. The synchronization processing unit 200 performs synchronization processing on the input image data which is in RGB Bayer array format, and generates color signals R, G and B.

The WB amplification unit 201 applies gain to the RGB color signals, based on a white balance gain value that is calculated by the system control unit 50, and adjusts the white balance. The WB amplification unit 201 inputs the white balance-adjusted RGB signals to the luminance and color signal generation unit 202.

The luminance and color signal generation unit 202 generates a luminance signal Y from the RGB signals, and outputs the generated luminance signal Y to the edge enhancement processing unit 203 and the color signals RGB to the color conversion processing unit 205.

The edge enhancement processing unit 203 performs edge enhancement processing on the luminance signal Y, and outputs the luminance signal Y to the luminance gamma possessing unit 204. The luminance gamma possessing unit 204 performs gamma correction on the luminance signal Y, and outputs the luminance signal Y to the image memory 106. The color conversion processing unit 205 performs desired color balance conversion through processing such as a matrix operation on the RGB signals. The color gamma processing unit 206 performs gamma correction on the RGB color signals. The color difference signal generation unit 207 generates color difference signals R-Y and B-Y from the RGB signals, and outputs the color difference signals to the image memory 106. The image signals (Y, R-Y, B-Y) output to the image memory 106 are compression encoded by the codec unit 110, and recorded to the recording medium 112.

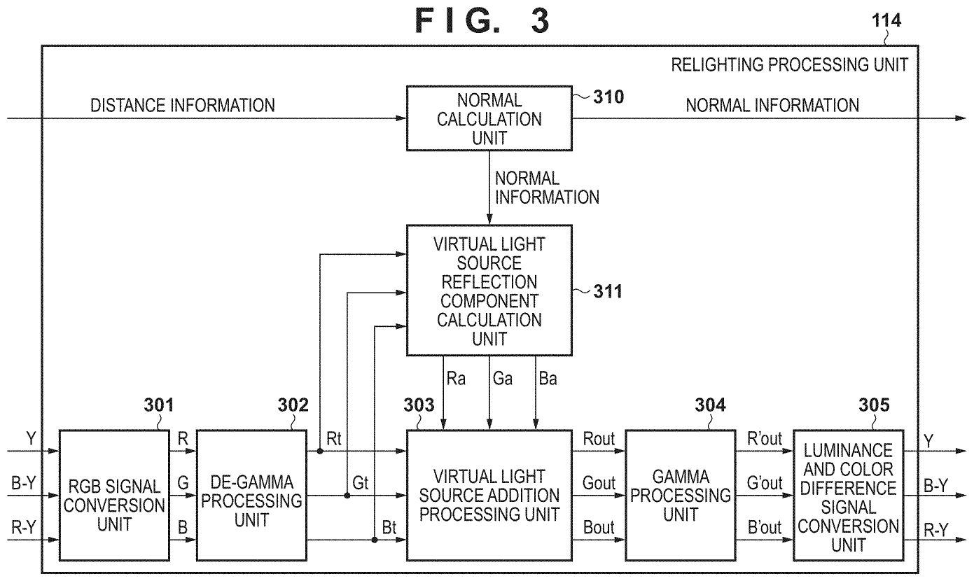

Next, the configuration and operations of the relighting processing unit 114 will be described, with reference to FIG. 3. In the case where execution of relighting processing is instructed by a user operation, the image data output by the image processing unit 105 is input to the relighting processing unit 114, and relighting processing using the virtual light source is performed.

FIG. 3 is a block diagram showing a configuration of the relighting processing unit 114. In FIG. 3, reference numeral 301 denotes an RGB signal conversion unit that converts input luminance and color difference signals (Y, B-Y, R-Y) into RGB signals. Reference numeral 302 denotes a de-gamma processing unit that performs de-gamma processing. Reference numeral 303 denotes a virtual light source addition processing unit that adds a relighting signal of the virtual light source to the image data. Reference numeral denotes 304 is a gamma processing unit that applies a gamma characteristic to the RGB signals. Reference numeral 305 denotes a luminance and color difference signal conversion unit that converts RGB signals into luminance and color difference signals (Y, B-Y, R-Y). Reference numeral 310 denotes a normal calculation unit that calculates the normal of an object from object distance information that is output by the ranging sensor 124. Reference numeral 311 denotes a virtual light source reflection component calculation unit that calculates the components of irradiated light of the virtual light source that is reflected by the object.

Operations of the relighting processing unit 114 having the above configuration will now be described. The relighting processing unit 114 reads out the luminance and color difference signals (Y, B-Y, R-Y) recorded in the image memory 106, and inputs the read signals to the RGB signal conversion unit 301. The RGB signal conversion unit 301 converts the input luminance and color difference signals (Y, B-Y, R-Y) into RGB signals, and outputs the RGB signals to the de-gamma processing unit 302. The de-gamma processing unit 302 calculates the opposite characteristic to the gamma characteristic applied in the gamma processing by the image processing unit 105, and converts the RGB signals into linear data. The de-gamma processing unit 302 outputs the RGB signals (Rt, Gt, Bt) after linear conversion to the virtual light source reflection component calculation unit 311 and the virtual light source addition processing unit 303.

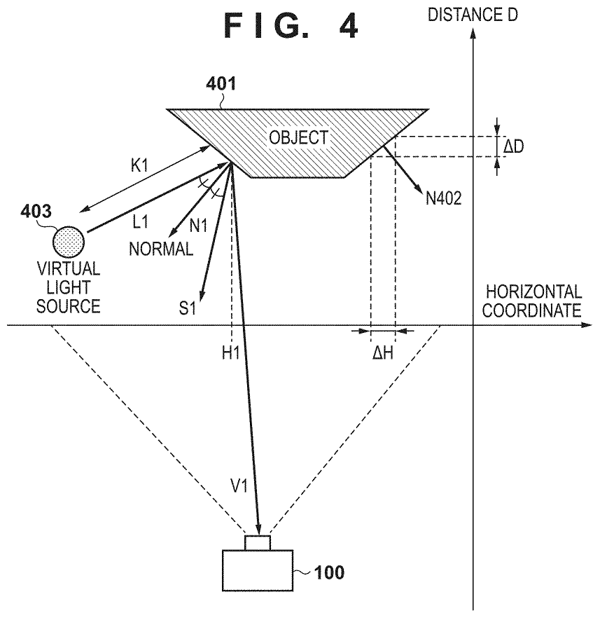

On the other hand, the normal calculation unit 310 calculates a normal map from the object distance information acquired from the ranging sensor 124. The object distance information is two-dimensional distance information obtained in pixel units of the shot image. In relation to the method of generating the normal map from the object distance information, any known technology can be used, and a specific processing example will now be described using FIG. 4.

FIG. 4 is a diagram showing the relationship between camera shooting coordinates and an object. For example, the case of calculating a normal N402 of an object 401 shown in FIG. 4 will be considered. In this case, it is possible for the normal calculation unit 310 to calculate gradient information from a difference AD of a distance (depth) D with respect to a difference AH of a shot image in the horizontal direction, and to calculate the normal N402 from the gradient information. The normal calculation unit 310, by performing the above processing on each pixel that is shot, calculates normal information corresponding to each pixel of the shot image. The normal calculation unit 310 outputs the normal information calculated for each pixel of the shot image as a normal map to the virtual light source reflection component calculation unit 311. The normal map is also output to the image memory 106 (FIG. 1), and is utilized in relighting parameter determination processing by the system control unit 50 described later.

The virtual light source reflection component calculation unit 311 calculates reflection components of irradiated light of the installed virtual light source that is reflected by the object or non-reflection components indicating the extent to which the irradiated light of the virtual light source does not strike the object. In the present embodiment, as a relighting mode for determining the effects of light irradiation by the virtual light source, it is possible to switch between the following three modes:
(1) Relighting that adds diffuse reflection components (diffuse mode)
(2) Relighting that reduces light (adds shadow) (shadow mode)
(3) Relighting that adds specular reflection components (specular mode)
   The virtual light source reflection component calculation unit 311 outputs signals corresponding to one of the relighting modes (1) to (3) (or a combination thereof), as (non-)reflection components signals (Ra, Ga, Ba). The virtual light source reflection component calculation unit 311 calculates the diffuse reflection components of the virtual light source in the case where the relighting mode is the diffuse mode, calculates the non-reflection components in the case where the relighting mode is the shadow mode, and calculates the specular reflection components in the case where the relighting mode is the specular mode.

Note that the reflection components and the non-reflection components are calculated based on a distance K between the virtual light source and the object, normal information N, a specular reflection direction S of the virtual light source, and virtual light source parameters. The calculation (determination) of the virtual light source parameters will be described later.

A specific example of a method of calculating the reflection components and the non-reflection components will now be described using FIG. 4. Reference numeral 401 denotes an object and 403 denotes a virtual light source.

In the case where the relighting mode is the diffuse mode, the virtual light source reflection component calculation unit 311 calculates the diffuse reflection components as follows. The diffuse reflection components at a horizontal pixel position H1 of a shot image shot with the digital camera 100 will be a value proportional to the inner product of a normal vector N1 at camera coordinates H1 and a direction vector L1 of the virtual light source, and inversely proportional to the square of the distance K1 between the virtual light source and the object position. Note that, in FIG. 4, the vertical pixel position is omitted for simplification of description. When this relationship is represented with a formula, the diffuse reflection components (Ra, Ga, Ba) by the virtual light source will be as follows.

$$Ra = {\sum }_{Lights} \{ α \times ( {k}_{d} \times \frac{( - L \cdot N )}{{K}^{2}} ) \times Rw \times Rt \} \\ Ga = {\sum }_{Lights} \{ α \times ( {k}_{d} \times \frac{( - L \cdot N )}{{K}^{2}} ) \times 1 \times Gt \} \\ Ba = {\sum }_{Lights} \{ α \times ( {k}_{d} \times \frac{( - L \cdot N )}{{K}^{2}} ) \times Bw \times Bt \} \qquad Formula 1$$

Here, α is the intensity of the virtual light source, L is a three-dimensional direction vector of the virtual light source, N is a three-dimensional normal vector of the object, K is the distance between the virtual light source and the object, and k_{d} is the diffuse reflectance of the object. The magnitudes of N and K are normalized to 1. Rt, Gt, and Bt are the RGB signals output by the de-gamma processing unit 302. Rw and Bw are parameters for controlling the color of the virtual light source.

Note that it is also possible to set a plurality of virtual light sources, and to control parameters for each virtual light source.

In the case where the relighting mode is the shadow mode, the virtual light source reflection component calculation unit 311 calculates the non-reflection components as follows. The non-reflection components are calculated using the complement (1−(−L·N)) of the degree of diffusion (−L·N), in order to show the degree to which the diffuse reflection components do not occur. Also, the non-reflection components (Ra, Ga, Ba) are taken as negative values, and these non-reflection components are subtracted from the shot image signals. Shadow can thereby be enhanced. When this relationship is represented with a formula, the non-reflection components (Ra, Ga, Ba) of the virtual light source will be as follows.

$$Ra = - {\sum }_{Lights} \{ α \times ( {k}_{d} \times \frac{( 1 - ( - L \cdot N ) )}{{K}^{2}} ) \times Rw \times Rt \} \\ Ga = - {\sum }_{Lights} \{ α \times ( {k}_{d} \times \frac{( 1 - ( - L \cdot N ) )}{{K}^{2}} ) \times 1 \times Gt \} \\ Ba = - {\sum }_{Lights} \{ α \times ( {k}_{d} \times \frac{( 1 - ( - L \cdot N ) )}{{K}^{2}} ) \times Bw \times Bt \} \qquad Formula 2$$

Note that, in the case of the shadow mode, shadow may be added using a virtual light source that irradiates lights for darkening an irradiated portion. In this case, the output components (Ra, Ga, Ba) of the virtual light source reflection component calculation unit 311 will be as follows.

$$Ra = - {\sum }_{Lights} \{ α \times ( {k}_{d} \times \frac{( - L \cdot N )}{{K}^{2}} ) \times Rw \times Rt \} \\ Ga = - {\sum }_{Lights} \{ α \times ( {k}_{d} \times \frac{( - L \cdot N )}{{K}^{2}} ) \times 1 \times Gt \} \\ Ba = - {\sum }_{Lights} \{ α \times ( {k}_{d} \times \frac{( - L \cdot N )}{{K}^{2}} ) \times Bw \times Bt \} \qquad Formula 3$$

In the case where the relighting mode is the specular mode, the virtual light source reflection component calculation unit 311 calculates the specular reflection components as follows. The specular reflection components are proportional to the inner product of the specular reflection direction S with respect to the object and a direction V toward the digital camera 100 from the object position (direction of the line of sight). When this relationship is represented with a formula, the specular reflection components (Ra, Ga, Ba) of the virtual light source will be as follows.

$$Ra = {\sum }_{Lights} \{ α \times ( {k}_{s } \times {( S \cdot V )}^{β} ) \times Rw \times Rt \} \\ Ga = {\sum }_{Lights} \{ α \times ( {k}_{s} \times {( S \cdot V )}^{β} ) \times 1 \times Gt \} \\ Ba = {\sum }_{Lights} \{ α \times ( {k}_{s} \times {( S \cdot V )}^{β} ) \times Bw \times Bt \} \qquad Formula 4$$

Here, S is a specular reflection vector of the virtual light source, V is a sight line direction vector indicating the direction toward the object position from the digital camera 100, and Kₛ is the specular reflectivity of the object. The magnitudes of S and V are normalized to 1. Also, β denotes a brightness coefficient indicating the spread of reflected light, and the specular reflection characteristics become steeper when this value increases.

Referred again to FIG. 3, the (non-)reflection components (Ra, Ga, Ba) of the virtual light source calculated as described above are output to the virtual light source addition processing unit 303. The virtual light source addition processing unit 303 performs the following processing for adding the (non-)reflection components (Ra, Ga, Ba) to the object region.

Rout=Rt+Ra

Gout=Gt+Ga

Bout=Bt+Ba Formula 5

The image signals (Rout, Gout, Bout) output by the virtual light source addition processing unit 303 are input to the gamma processing unit 304. The gamma processing unit 304 performs gamma correction on the input RGB signals. The luminance and color difference signal conversion unit 305 generates a luminance signal Y and color difference signals R-Y and B-Y from the RGB signals.

The above are the operations of the relighting processing unit 114. The system control unit 50 performs compression encoding with the codec unit 110, after storing the luminance and color difference signals output by the relighting processing unit 114 in the image memory 106, under the control of the memory control unit 107. Also, the system control unit 50 records compression encoded image data in the recording medium 112 via the I/F111.

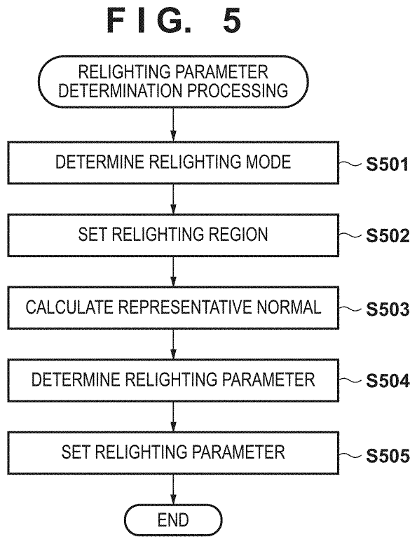

Next, processing in which the system control unit 50 determines parameters (parameters of the virtual light source) of the relighting processing unit 114 will be described, with reference to FIG. 5. The system control unit 50, prior to relighting processing, accepts an operation to an operation unit 120 by the user, for turning on relighting processing. In the case where relighting processing is on, the system control unit 50 determines parameters of the virtual light source, in accordance with the flowchart shown in FIG. 5.

In step S501, the system control unit 50 determines the relighting mode, according to an operation on the operation unit 120 by the user. In the present embodiment, as aforementioned, the user can select any of the diffuse mode, the shadow mode and the specular mode as the relighting mode by a menu operation.

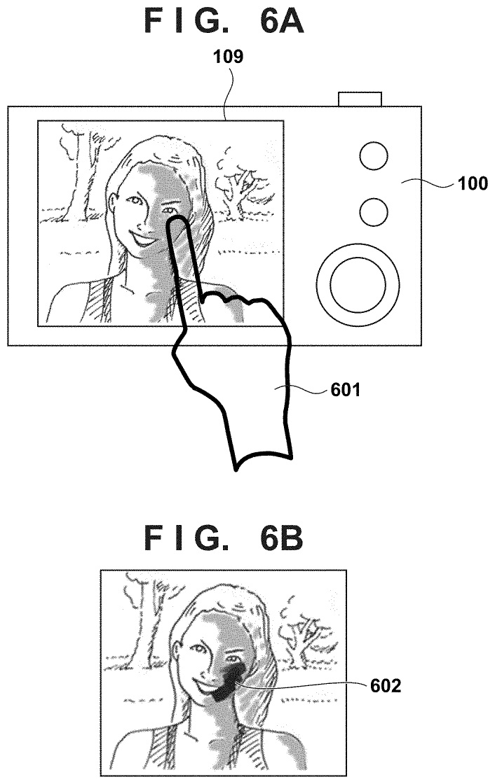

In step S502, the system control unit 50 sets a region to throw in light (or to cast in shadow) by relighting, according to an operation on the operation unit 120 by the user. FIGS. 6A and 6B are diagrams showing user operations at the time of setting a relighting region (hereinafter, referred to as “correction region” or “designated region”, etc.). In FIG. 6A, the display unit 109 is a touch-operable liquid crystal display monitor. Reference numeral 601 denotes the user's hand.

As shown in FIG. 6A, the user selects a region he or she wants to correct within the shot image displayed on the display unit 109, by tracing the region with a finger. The system control unit 50 sets the selection region selected by the user as a correction region. In FIG. 6B, reference numeral 602 denotes the correction region selected by the user. In this way, the user is able to directly designate a region in which he or she wants to add light (or add shadow) by relighting.

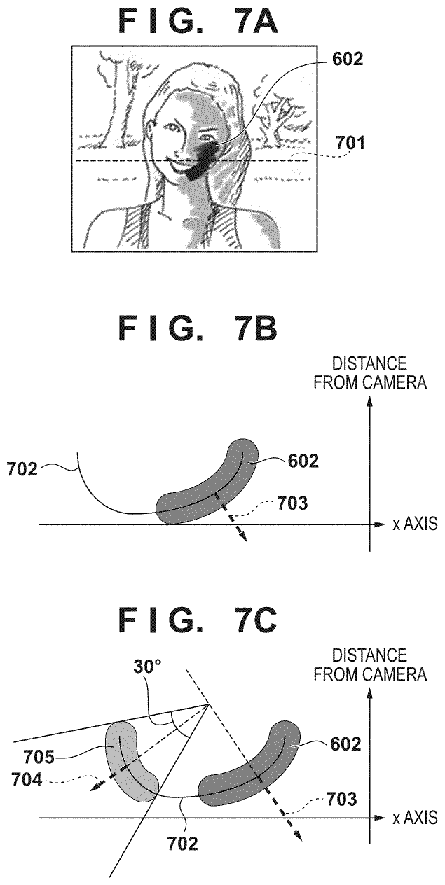

Returning to FIG. 5, in step S503, the system control unit 50 calculates a representative normal of the correction region 602, utilizing the normal information output by the normal calculation unit 310 (FIG. 3). Calculation of the representative normal will now be described in detail using FIGS. 7A to 7C.

FIG. 7A shows a shot image. Here, for simplification of description, a method of calculating the representative normal in relation to a horizontal line 701 will be described, but it is also possible to calculate a representative normal that takes all lines including the correction region 602 into consideration.

In the case where the relighting mode is the diffuse mode or the specular mode, a representative normal is calculated by the calculation method shown in FIG. 7B. In FIG. 7B, reference numeral 702 denotes an object distance (distance of person's face region) on the horizontal line 701. The system control unit 50 reads out the normal information on the pixels included in the correction region 602 from the image memory 106, and averages the normal vectors that are included in the correction region 602. At this time, the normal vectors are normalized in advance. Also, the system control unit 50 calculates an average value of the coordinate positions of the shot image that are included in the correction region 602 (centroid of the correction region 602), and sets the coordinate average as the origin of the representative normal. That is, the normal information includes information indicating a plurality of normals corresponding to a plurality of positions in the correction region 602, and the system control unit 50 determines a representative normal that passes through the centroid of the correction region 602, based on this plurality of normals. As a result, a representative normal 703 is calculated.

In the case where the relighting mode is the shadow mode, a representative normal and an orthogonal representative normal are calculated by a calculation method shown in FIG. 7C. First, the system control unit 50 calculates the representative normal 703, by a similar calculation method to FIG. 7B. The system control unit 50 then calculates an orthogonal representative normal vector having a direction orthogonal to the representative normal 703. Next, the system control unit 50 derives an origin of the orthogonal representative normal vector. Specifically, the system control unit 50 detects an object region 705 whose angle formed with an orthogonal representative normal vector that is orthogonal to the representative normal 703 is within a predetermined angle (e.g., 30 degrees). The system control unit 50 sets the coordinate average of the object region 705 as the origin of the orthogonal representative normal vector. As a result, an orthogonal representative normal 704 is obtained.

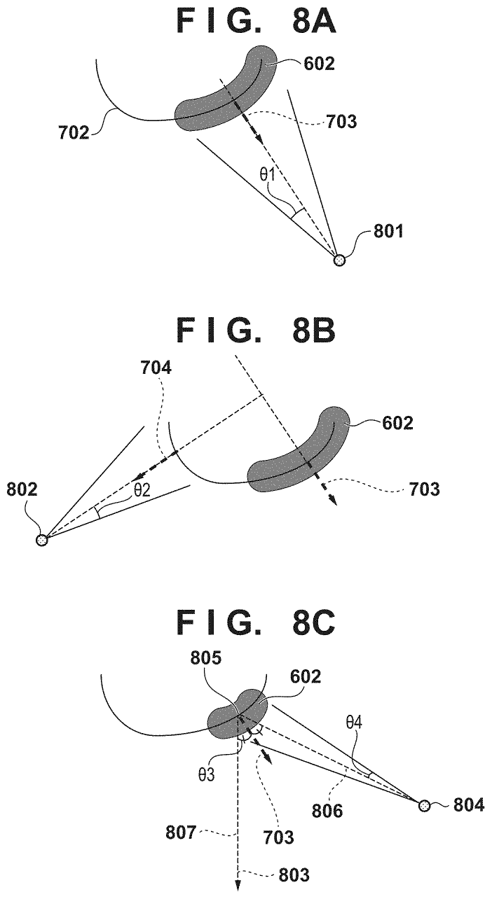

Returning to FIG. 5, in step S504, the system control unit 50 determines parameters (including at least one of position and direction) of the virtual light source, utilizing the representative normal 703 or the orthogonal representative normal 704 calculated in step S503. Hereinafter, a parameter determination method will be described, using FIGS. 8A to 8C.

FIGS. 8A to 8C are diagrams illustrating a method of determining parameters of the virtual light source corresponding to each of the three relighting modes. FIG. 8A corresponds to the diffuse mode, FIG. 8B corresponds to the shadow mode, and FIG. 8C corresponds to the specular mode.

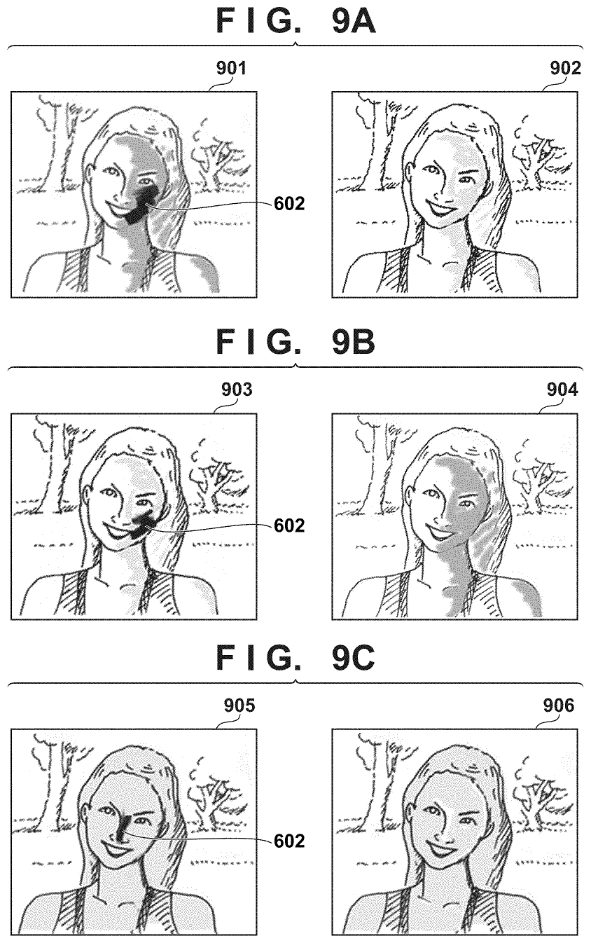

In the case where the relighting mode is the diffuse mode, the system control unit 50, as shown in FIG. 8A, disposes the virtual light source on the direction line of the representative normal 703. When the distance K between the object and the virtual light source is given as a predetermined fixed value, the position of a virtual light source 801 is obtained. Also, an irradiation range θ1 of the virtual light source 801 is determined so as to be an angle that contains the entire correction region 602. As can be seen from FIG. 8A, parameters of the virtual light source are determined such that irradiated light of the virtual light source travels toward the correction region 602 along the representative normal 703. The result of performing relighting (processing for correcting the shot image such that light irradiation by the virtual light source is applied) with parameters determined in this way is shown in FIG. 9A. In FIG. 9A, reference numeral 901 denotes the shot image before relighting and 902 denotes the shot image after relighting. It is possible to perform relighting such that the correction region 602 becomes brighter, by adding diffusely reflected light from the direction of the representative normal 703 to the shot image.

In the case where the relighting mode is the shadow mode, the system control unit 50, as shown in FIG. 8B, disposes the virtual light source on the direction line of the orthogonal representative normal 704. When the distance K between the object and the virtual light source is given as a predetermined fixed value, the position of the virtual light source 802 is obtained. Also, an irradiation range θ2 of the virtual light source 802 is determined so as to be an angle that does not contain any of the correction region 602. In this way, parameters of the virtual light source are determined such that the irradiated light of the virtual light source does not strike the correction region 602. The result of performing relighting with parameters determined in this way is shown in FIG. 9B. In FIG. 9B, reference numeral 903 denotes the shot image before relighting and 904 denotes the shot image after relighting. It is possible to perform relighting such that the correction region 602 becomes darker, by assuming a virtual light source from the direction of the orthogonal representative normal 704, and performing control for subtracting the signals of regions that the virtual light source does not strike.

In the case where the relighting mode is the specular mode, the system control unit 50 disposes the virtual light source in a direction in which specular reflection components are most likely to occur when viewed from the direction of the line of sight of the camera. Specifically, the system control unit 50, as shown in FIG. 8C, has the same angle as an angle 03 formed by a camera sight line direction 803 and the representative normal 703, and disposes the virtual light source on the opposite direction line to the camera sight line direction 803. The distance K between the object and the virtual light source is given as a predetermined fixed value. As a result, the position of the virtual light source 804 is obtained. Also, an irradiation range 04 of the virtual light source 804 is determined so as to be an angle that contains the entire correction region 602. Furthermore, the system control unit 50 controls the brightness coefficient β indicating the extent of the spread of reflected light, according to the width of the horizontal line of the correction region 602. If the correction region 602 has a narrow width, steep specular reflection is generated by increasing β, and if the correction region 602 has a wide width, gentle specular reflection is generated by reducing β. As can be seen from FIG. 8C, parameters of the virtual light source are determined such that irradiated light of the virtual light source travels toward the correction region 602 along a specific line 806 that passes through an intersection 805 of the representative normal 703 and the correction region 602. The representative normal 703 passes between the line 806 and a line 807 in the depth direction (camera sight line direction 803) that passes through the intersection 805. The result of performing relighting with parameters determined in this way is shown in FIG. 9C. In FIG. 9C, reference numeral 905 denotes the shot image before relighting, and 906 denotes the shot image after relighting. It is possible to perform relighting such that specular reflection occurs in the correction region 602, by setting the virtual light source to an angle at which specular reflection most occurs.

Returning to FIG. 5, in step S505, the system control unit 50 sets the relighting parameters (parameters of the virtual light source) determined in step S504 in the virtual light source reflection component calculation unit 311 (FIG. 3).

Hereinabove, the relighting parameter determination processing has been described. The relighting processing unit 114 corrects the shot image such that light irradiation by the virtual light source is applied, based on parameters determined in this way.

As described above, according to the first embodiment, the digital camera 100 accepts selection of a correction region by the user, calculates a representative normal from normal information relating to the correction region, and determines parameters of the virtual light source based on the representative normal. It is thereby possible to determine parameters of a virtual light source that performs virtual light irradiation on an object with a simple user operation.

Note that, in the above description, the user selects one of the diffuse mode, the shadow mode and the specular mode as the relighting mode, but the types of relighting mode that can be selected are not limited thereto. For example, a mode that combines a plurality of the above three modes, such as a mode that adds both diffuse reflection components and specular reflection components, or a mode other than those described above may be added as a selectable mode. The method of determining parameters of the virtual light source may take any form as long as the method is based on the distribution of normals in the correction region and the irradiation characteristics of the light source.

Also, the model for calculating the intensity of diffuse reflection components and specular reflection components is not limited to that of the formulas described above. Any calculation method may be adopted as long as the method involves calculating the position and direction at which the reflection components increase, according to the model that is employed, and determining parameters of the virtual light source based thereon.

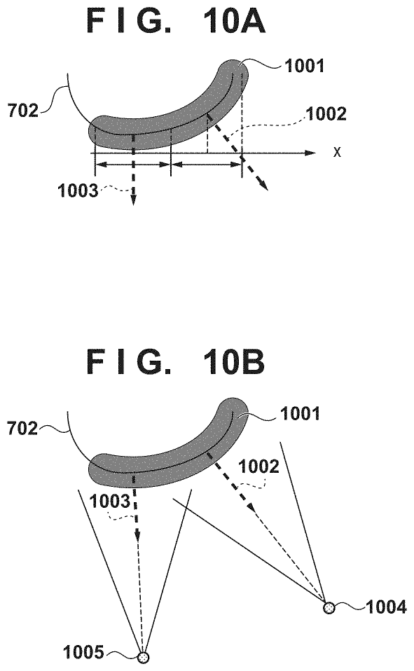

Also, in the above description, one representative normal is calculated for one selection region (correction region), but it also is possible to adopt a configuration in which a plurality of representative normals are calculated, in the case where the size of the selection region meets a predetermined condition (e.g., in the case where the selection region is large). FIGS. 10A and 10B show an example of processing in the case where the selection region selected by the user is large. In FIGS. 10A and 10B, reference numeral 1001 denotes the selection region. The system control unit 50 determines the spread of the directions of the normals that are included in the selection region 1001, and, in the case where the variation in distribution of the normals is large, divides the selection region 1001 into a plurality of regions, and sets each of the plurality of regions as a correction region. In the example of FIG. 10A, the system control unit 50 divides the selection region 1001 into two correction regions, and calculates a representative normal for each divided correction region. Reference numerals 1002 and 1003 denote the representative normal of each divided correction region. The system control unit 50 respectively calculates parameters of the virtual light sources for these two representative normals 1002 and 1003. The calculation method is similar to the calculation method described above. The positions of the calculated virtual light sources are shown in FIG. 10B. The position of the virtual light source 1004 is obtained for the representative normal 1002, and the position of the virtual light source 1005 is obtained for the representative normal 1003. By performing such control, it is possible to irradiate virtual light sources over a broad area, even in the case where the user has selected a large area as the selection region.

Also, in the above description, the number of the correction regions that are selected by the user is given as one, but the number of correction regions that can be selected is not limited to one, and a configuration may be adopted in which a plurality of correction regions can be selected. In this case, the system control unit 50 sets a virtual light source for each correction region. In relation to regions close to the direction of the representative normal, however, control such as collectively setting one virtual light source may be performed.

Also, in the above description, the representative normal is calculated from an average value of normals included in the correction region (a plurality of normals corresponding to a plurality of positions in the correction region), but the method of calculating the representative normal is not limited thereto. For example, a representative normal may be calculated from a median value of a plurality of normals, or a representative normal may be calculated from a peak value obtained by converting the directions of a plurality of normals into a histogram. That is, the direction of the representative normal may be the average value, median value or mode value of the directions of a plurality of normals. Alternatively, normal information may include information indicating the normal of a coordinate average value (centroid) of the correction region, and this normal may be used as the representative normal.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-148851, filed Aug. 7, 2018 which is hereby incorporated by reference herein in its entirety.

What is claimed is:

1. An image processing apparatus comprising at least one processor and/or at least one circuit which function as:
a setting unit configured to set a correction region in an object of an image;
an acquisition unit configured to acquire normal information relating to the correction region;
a determination unit configured to determine, based on the normal information, a parameter of a virtual light source that performs virtual light irradiation on the object; and
a correction unit configured to correct the image such that light irradiation by the virtual light source is applied.

2. The image processing apparatus according to claim 1,
wherein the normal information includes information indicating a plurality of normals corresponding to a plurality of positions in the correction region, and
the determination unit determines a representative normal based on the plurality of normals, and determines the parameter based on the representative normal.

3. The image processing apparatus according to claim 2,
wherein a direction of the representative normal is an average value, a median value or a mode value of directions of the plurality of normals.

4. The image processing apparatus according to claim 2,
wherein the representative normal passes through a centroid of the correction region.

5. The image processing apparatus according to claim 1,
wherein the normal information includes information indicating a representative normal which is a normal at a centroid of the correction region, and
the determination unit determines the parameter based on the representative normal.

6. The image processing apparatus according to claim 2, wherein the at least one processor and/or the at least one circuit further function as
a selection unit configured to select an effect of light irradiation by the virtual light source,
wherein the determination unit determines the parameter of the virtual light source, based on the selected effect and the representative normal.

7. The image processing apparatus according to claim 6,
wherein, in a case where the selected effect is an effect that adds a diffuse reflection component to the correction region, the determination unit determines the parameter of the virtual light source, such that irradiated light of the virtual light source travels to the correction region along the representative normal.

8. The image processing apparatus according to claim 6,
wherein, in a case where the selected effect is an effect that adds a specular reflection component to the correction region, the determination unit determines the parameter of the virtual light source, such that irradiated light of the virtual light source travels to the correction region along a specific line that passes through an intersection of the representative normal and the correction region, and
the representative normal passes between the specific line and a line in a depth direction of the image that passes through the intersection.

9. The image processing apparatus according to claim 6,
wherein, in a case where the selected effect is an effect that adds shadow to the correction region,
the determination unit determines the parameter of the virtual light source such that irradiated light of the virtual light source does not strike the correction region, and
the correction unit corrects the image so as to darken a region that the irradiated light of the virtual light source does not strike.

10. The image processing apparatus according to claim 1,
wherein the parameter of the virtual light source includes at least one of a position and a direction of the virtual light source.

11. The image processing apparatus according to claim 1,
wherein the setting unit sets, as the correction region, a selection region selected by a user in the object of the image.

12. The image processing apparatus according to claim 11,
wherein, in a case where the selection region meets a predetermined condition, the setting unit divides the selection region into a plurality of regions, and sets each of the plurality of regions as the correction region.

13. The image processing apparatus according to claim 1, wherein the at least one processor and/or the at least one circuit further function as
an image capturing unit configured to generate the image.

14. An image processing method executed by an image processing apparatus, comprising:
setting a correction region in an object of an image;
acquiring normal information relating to the correction region;
determining, based on the normal information, a parameter of a virtual light source that performs virtual light irradiation on the object; and
correcting the image such that light irradiation by the virtual light source is applied.

15. A non-transitory computer-readable storage medium which stores a program for causing a computer to execute an image processing method comprising:
setting a correction region in an object of an image;
acquiring normal information relating to the correction region;
determining, based on the normal information, a parameter of a virtual light source that performs virtual light irradiation on the object; and
correcting the image such that light irradiation by the virtual light source is applied.
